(19) United States
(12) Patent Application Publication
(10) Pub. No.: US 2024/0397463 A1
(43) Pub. Date: Nov. 28, 2024

(54) TIMING ADVANCE IN MULTI-PANEL TX SCENARIO

(71) Applicant: LENOVO (BEIJING) LIMITED, Beijing (CN)

(72) Inventors: Ran Yue, Beijing (CN); Bingchao Liu, Beijing (CN); Lianhai Wu, Beijing (CN); Jing Han, Beijing (CN); Haiming Wang, Beijing (CN)

(21) Appl. No.: 18/695,435

(22) PCT Filed: Sep. 29, 2021
(86) PCT No.: PCT/CN2021/121758

§ 371 Date: Mar. 26, 2024

(51) Int. Cl. H04W 56/00

(52) U.S. Cl. CPC H04W 56/0045; H04W 56/001

(57) ABSTRACT

Methods and apparatuses for timing advance in multi-panel TX scenario are disclosed. A user equipment (UE) comprises a processor; and a transceiver coupled to the processor, wherein the processor is configured to: receive, via the transceiver, information relating to multiple timing advances (TAS) for uplink transmission to a network, wherein each TA is associated with a link associated with a cell of the network; and determine each TA from the information received via the transceiver, for performing uplink transmission to one or more cells of the network.

### FIELD

The subject matter disclosed herein generally relates to wireless communications, and more particularly relates to methods and apparatuses for timing advance in multi-panel TX scenario.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), time alignment or timing advance or timing adjustment (TA), timing advance group (TAG), primary TAG (PTAG), secondary TAG (STAG), Timing Advance Command (TAC), Timing Advance Timer (TAT), Random Access Channel (RACH), Random Access Response (RAR), Transmit-Receive Point (TRP), time division multiplexing (TDM), control resource set (CORESET), reference signal (RS), Medium Access Control (MAC), MAC Control Element (MAC CE), Logical Channel Index (LCID), Downlink Shared Channel (DL-SCH), protocol data unit (PDU), hybrid automatic repeat-request (HARQ), Physical Uplink Control Channel (PUCCH), Physical Uplink Shared Channel (PUSCH), Channel State Information (CSI), sounding reference signal (SRS), Physical Downlink Control Channel (PDCCH).

TA, which can represent time alignment or timing advance or timing adjustment, is used to adjust the uplink frame timing relative to the downlink frame timing. A TA value, which can be the amount of timing adjustment, depends on the propaganda delay of the signal from the gNB to the UE. So, different UEs have different TAs relative to the gNB. The MAC entity of a UE manages the TA of the UE.

Traditionally, a UE can be served by a plurality of serving cells. Among the plurality of serving cells, a group of cells, when configured with UL transmission, using the same timing reference cell and the same TA value, belong to a timing advance group (TAG). The TAG containing the SpCell is referred to as primary TAG (PTAG), while each of other TAGs is referred to as secondary TAG (STAG).

FIG. 1 illustrates an example of legacy PTAG and STAG. It can be seen from FIG. 1 that SpCell #1 and SCell #2 belong to PTAG, and SCell #3 belongs to STAG. The UE manages one TA (e.g. one TA value) for one TAG. It means that, for the UE, SpCell #1 and SCell #2 have the same TA (e.g. TA1), while SCell #3 has another TA (e.g. TA2). From the UE's point of view, each cell (e.g. each of SpCell #1, SCell #2 and SCell #3) has one TA, no matter whether the TA value of a cell (e.g. TA1 for SpCell #1) is the same as the TA value of another cell (e.g. TA1 for SCell #2) or is different from the TA value of yet another cell (e.g. TA2 for SCell #3).

A cell may have multiple (e.g. two) TRPs. A UE may transmit UL signals (e.g. PUSCH transmission and/or PUCCH transmission) to multiple TRPs. In NR Release 17, the multiple TRPs are limited to two TRPs. In addition, the UE may only transmit UL signals, e.g. with two panels of the UE, to two TRPs in a TDM manner (i.e. asynchronously, instead of simultaneously). When the multiple (e.g. two) TRPs are close enough, the TA between the UE and one TRP and the TA between the UE and the other TRP can be regarded the same. Accordingly, even a cell may have multiple (e.g. two) TRPs, the UE still assumes one TA value for the cell.

To extend the cell coverage, multiple TRPs are likely to be put in different locations within the cell. In this condition, the TA from a UE to one of multiple TRPs and the TA from the UE to another of the multiple TRPs (e.g. two TRPs) will be different significantly. It means that, the UE should transmit a UL signal to one TRP of a cell by using one TA and transmit the same UL signal or another UL signal to another TRP of the cell by using another TA.

So, the UE needs to manage at least two TAs for a cell having multiple (e.g. two) TRPs that are located differently. When the UE transmits UL signals to multiple (e.g. two) TRPs of a cell, the UE generally has multiple (e.g. two) panels, each of which is used to transmit UL signal to a different TRP. This can be referred to as multi-panel multi-TRP scenario.

This invention targets enhancement of TA in multi-panel multi-TRP scenario.

### BRIEF SUMMARY

Methods and apparatuses for timing advance in multi-panel TX scenario are disclosed.

In one embodiment, a UE comprises a processor; and a transceiver coupled to the processor, wherein the processor is configured to: receive, via the transceiver, information relating to multiple timing advances (TAs) for uplink transmission to a network, wherein each TA is associated with a link associated with a cell of the network; and determine each TA from the information received via the transceiver, for performing uplink transmission to one or more cells of the network. The processor may further configured to: receive, via the transceiver, one or multiple timers, wherein, each timer is associated with one or multiple links and maintains a validity of the TAs associated with the one or multiple links. In particular, the timer relates to a timing advance group (TAG) for each link, or to a link for each TAG.

In one embodiment, the processor is further configured to: transmit, via the transceiver, a UE capability of supporting multiple TA maintenance

In another embodiment, the timer relates to a timing advance group (TAG) for each link, or to a link for each TAG.

In some embodiment, the link that is used to perform initial access is a primary link. The primary link may be associated with a cell. The one or multiple other link(s) are secondary link(s). Each secondary link may be associated with one or multiple cells.

In one embodiment, each TA may be indicated by a timing advance command (TAC). The TAC received from a downlink (DL) transmit-receive point (TRP) or DL beam set may be applied for an uplink (UL) panel associated with the DL TRP or a UL beam associated with the DL beam. Alternatively, each TAC is contained in a TAC medium access control (MAC) control element (CE) that identifies a link associated with the TAC. The TAC MAC CE may be of fixed size or variable size identified by MAC subheader with logical channel identity (LCID). Alternatively, the TAC contained in a TAC MAC CE that does not identify the link is determined as the TAC of the primary link. Alternatively, each TAC is contained in an MAC random access response (RAR) that identifies a link associated with the TAC. The MAC RAR may be of fixed size or variable size identified by MAC subheader with logical channel identity (LCID).

In some embodiment, if the timer associated with a link that is associated with configured uplink grants or UL resources is expired, the transmission on the UL resources may be suspended or the resources associated with the link may be cleared.

In another embodiment, a network device comprises a processor; and a transceiver coupled to the processor, wherein the processor is configured to: generate information relating to multiple timing advances (TAs) for uplink transmission from a user equipment (UE) to the network device, wherein each TA is associated with a link between the network device and the UE; and transmit, via the transceiver, the information relating to multiple TAs to the UE.

In yet another embodiment, a method performed by a UE comprises: receiving information relating to multiple timing advances (TAs) for uplink transmission to a network, wherein each TA is associated with a link associated with a cell of the network; and determining each TA from the information received from the transceiver, for performing uplink transmission to one or more cells of the network.

In further embodiment, a method performed at a network device comprises; generating information relating to multiple timing advances (TAs) for uplink transmission from a user equipment (UE) to the network device, wherein each TA is associated with a link between the network device and the UE; and transmitting the information relating to the multiple TAs to the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of legacy PTAG and STAG;

FIG. 2 illustrates an example of the second sub-embodiment of the first embodiment;

FIG. 3 illustrates an example of the fourth sub-embodiment of the first embodiment;

FIGS. 4(a) to 4(e) illustrate examples of new TAC MAC CE formats;

FIG. 5 is a schematic flow chart diagram illustrating an embodiment of a method;

FIG. 6 is a schematic flow chart diagram illustrating a further embodiment of a method; and

FIG. 7 is a schematic block diagram illustrating apparatuses according to one embodiment.

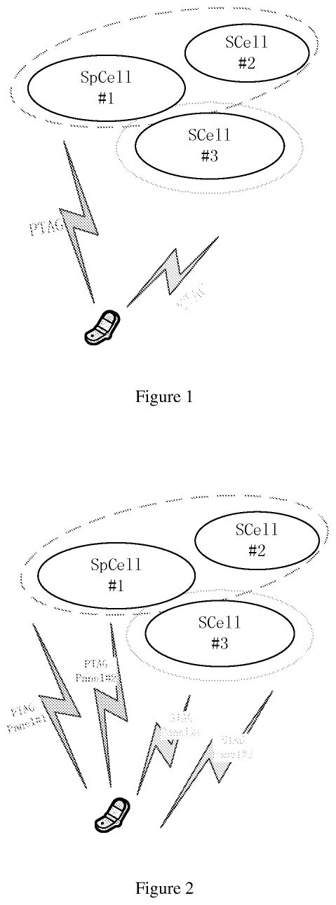

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

In multi-panel multi-TRP scenario, the UE is required to manage multiple TAs (e.g. from a same TAG) simultaneously. As mentioned in the background part, the TA mentioned in this application refers to time alignment or timing advance or timing adjustment, while TA value in this application refers to the amount of timing adjustment.

A first embodiment relates to modeling the multiple TAs in multi-panel multi-TRP scenario. “Multi-TRP” means that a serving cell can have multiple (e.g. two) TRPs. “Multi-panel” means that a UE can have multiple (e.g. two) panels. In the condition that a UE with two panels (e.g. panel #1 and panel #2) transmits UL signal (PUCCH and/or PUSCH transmissions) to a serving cell with two TRPs (e.g. TRP #1 and TRP #2), the UE may use one panel (e.g. panel #1) to transmit UL signal to one TRP (e.g. TRP #1) of the serving cell and use the other panel (e.g. panel #2) to transmit UL signal to another TRP (e.g. TRP #2) of the serving cell.

The TRP #1 and the TRP #2 of the serving cell may be located differently, which leads to the TA (e.g. TA1) adopted in transmitting UL signal from panel #1 to TRP #1 and the TA (e.g. TA2) adopted in transmitting UL signal from panel #2 to TRP #2 are different. The UE is necessary to manage multiple different TAs (e.g. TA1 and TA2) for one serving cell. TA1 can be indicated as a TA associated with a link (e.g. link #1) from panel #1 to TRP #1, and TA2 can be indicated as a TA associated with a link (e.g. link #2) from panel #2 to TRP #2.

In the present application, a link is defined so that that a different link is associated with a different TA. A link can be indicated as from a panel to a TRP. Since a particular panel (e.g. panel #1) is used to transmit UL signal to a particular TRP (e.g. TRP #1), a link may be indicated as a panel or a TRP. For example, if link #1 from panel #1 to TRP #1 is associated with TA #1 and link #2 from panel #2 to TRP #1 is associated with TA #2, then TA #1 associated with link #1 can be indicated as TA #1 associated with panel #1 while TA #2 associated with link #2 can be indicated as TA #2 associated with panel #2. For another example, if link #1 from panel #1 to TRP #1 is associated with TA #1 and link #2 from panel #1 to TRP #2 is associated with TA #2, then TA #1 associated with link #1 can be indicated as TA #1 associated with TRP #1 while TA #2 associated with link #2 can be indicated as TA #2 associated with TRP #2. Apparently, a link may alternatively be indicated as a panel set (or panel group) or a TRP set (or TRP group) suppose that the same TA is associated with a panel set (consisting of multiple panels) or with a TRP group (consisting of multiple TRPs). Multiple beams are sent from a panel. In addition, multiple beams used for receiving belong to a TRP. Accordingly, a beam or a beam set (or beam group) consisting of multiple beams may alternatively indicate a link. A panel corresponds to a set of reference signals (RSs) (maybe referred to as RS set). A TRP corresponds to a pool of CORESETs with the same CORESETPoolIndex. So, an RS set or a CORESET pool may alternatively indicate a link. Alternatively, a cell (a serving cell or a non-serving cell) may indicate a link. Each of the above-identified items to indicate a link (e.g. panel, panel set, TRP, TRP set, beam, beam set, RS set, CORESET pool, cell) may have an index (ID), which means that the ID of each of the above-identified items may alternatively indicate a link. In addition, a beam failure detection ID may alternatively indicate a link. Incidentally, in a multi-TRP (i.e. multiple TRPs (e.g. two TRPs)) scenario, the multiple TRPs (e.g. two TRPs) may belong to different cells (e.g. two cells). In this condition, a link may be associated with multiple (e.g. two) cell.

According to a first sub-embodiment of the first embodiment, the TA is identified per link (e.g. per link per cell). That is, each link has a separate TA. It means that a TA (i.e. one TA) is configured to be associated with each link. The UE manages or maintains one TA for each link. A TA timer (TAT) (e.g. timeAlignmentTimer) is configured by RRC signaling per TA (i.e. per link) or per multiple TAs (i.e. per cell) (it means that all links of a cell, each of which has a different TA, have the same TAT). In other words, each TAT is associated with one or multiple links. The TAT associated with a link maintains a validity of the TA associated with the link. The validity of the TA means how long the TA is valid or how long the MAC entity of the UE considers that the TA is valid.

Optionally, the UE may indicate a UE capability that supports multiple TA maintenance (e.g. supports that “TA is identified per link”) to the base station (e.g. gNB), so that TA can be identified per link.

Optionally, the link that is used or configured or indicated to perform initial access can be defined or configured by RRC signaling as “primary link”. The primary link may be associated with a cell. The other links (i.e. the links that are not primary link) can be defined as “secondary link(s)” or “other link(s)”. Each secondary link may be associated with one or multiple (e.g. two) cells.

According to the first sub-embodiment of the first embodiment, if multiple TAs, each of which is identified per link, are configured, the TAG (either PTAG or STAG) is not allowed to be configured by the base station, or the TAG is considered as disabled by the UE even if it is configured by the base station.

According to a second sub-embodiment of the first embodiment, the TA is identified per TAG per link (i.e. for each link in each TAG). That is, each link in each TAG has a separate TA. It means that a TA is associated with each link of each TAG. FIG. 2 illustrates an example of the second sub-embodiment of the first embodiment. In FIG. 2, a link is indicated by a panel (e.g. Panel #1, Panel #2). FIG. 2 shows four links: Panel #1 of PTAG, Panel #2 of PTAG, Panel #1 of STAG, and Panel #2 of STAG. So, the UE is necessary to manage or maintain one TA for each of the four links. A TA timer (e.g. timeAlignmentTimer) is configured by RRC signaling per TA (i.e. per TAG per link) or per TAG (it means that all links of a TAG, each of which has a different TA, have the same TAT). For example, timeAlignmentTimer_TAG 1-1 is configured to be associated with Panel #1 of PTAG; timeAlignmentTimer_TAG 1-2 is configured to be associated with Panel #2 of PTAG; timeAlignmentTimer_TAG 2-1 is configured to be associated with Panel #1 of STAG; and timeAlignmentTimer_TAG 2-2 is configured to be associated with Panel #2 of STAG.

Optionally, the UE may indicate a UE capability that supports multiple TA maintenance (e.g. supports that “TA is identified per TAG per link”) to the base station (e.g. gNB), so that TA can be identified per TAG per link.

Optionally, a link of PTAG that is used or configured or indicated to perform initial access can be defined as “primary link”. Alternatively, one link can be configured by the network as “primary link”. The other links (i.e. the links that are not primary link) can be defined as “secondary link(s)” or “other link(s)”. Optionally, a link of each TAG (e.g. each STAG) that is used or configured or indicated to perform initial access can be defined or configured by RRC signaling as “primary link” (e.g. “primary link of the STAG”). Alternatively, one link in a TAG (e.g. STAG) can be indicated or defined or configured by the network as “primary link” (e.g. “primary link of the STAG”). The other links (i.e. the links that are not primary link) in the TAG can be defined as “secondary link(s)” or “other link(s)” of the TAG.

The TAG configuration follows the legacy TAG configuration.

According to a third sub-embodiment of the first embodiment, legacy TAG is reused, and the TA indicated in the legacy TAG and the TAT associated with the legacy TAG are regarded as the TA and the TAT associated with primary link, where the link that is used or configured or indicated to perform initial access can be defined or configured by RRC signaling as “primary link”. The other links (i.e. the links that are not primary link) can be defined as “secondary link(s)” or “other link(s)”. Alternatively, a link of each TAG (e.g. each STAG) that is used or configured or indicated to perform initial access can be defined or configured by RRC signaling as “primary link” (e.g. “primary link of the STAG”). Alternatively, one link in a TAG (e.g. STAG) can be indicated or defined or configured by the network as “primary link” (e.g. “primary link of the STAG”). The other links (i.e. the links that are not primary link) in the TAG can be defined as “secondary link(s)” or “other link(s)” of the TAG. The TAs of the other links are identified per link. A new TAT (e.g. timeAlignmentTimer_additionalpanel) is configured to be associated with each of the “secondary link(s)” or “other link(s)”.

Optionally, the UE may indicate a UE capability that supports multiple TA maintenance (e.g. “legacy TAG is reused to identify primary link, and the other TA(s) associated with other link(s) are identified per link”) to the base station (e.g. gNB). According to the third sub-embodiment of the first embodiment, TA of primary link can be identified by legacy TAG and TA of other links can be identified per link.

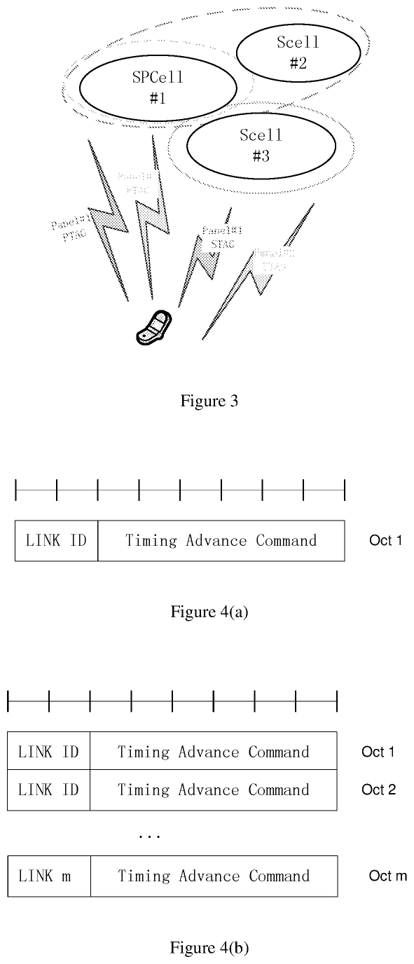

According to a fourth sub-embodiment of the first embodiment, the TA is identified per link per TAG (i.e. for each TAG in each link). That is, each TAG in each link has a separate TA. It means that a TAG is configured to be associated with a link. FIG. 3 illustrates an example of the fourth sub-embodiment of the first embodiment. In FIG. 3, a link is indicated by a panel (e.g. Panel #1, Panel #2). FIG. 3 shows four links: PTAG of Panel #1, PTAG of Panel #2, STAG of Panel #1, STAG of Panel #2. So, the UE is necessary to manage or maintain one TA for each of the four links. A TA timer (e.g. timeAlignmentTimer) is configured by RRC signaling per TA (i.e. per link per TAG) or per TAG (it means that all links associated with a TAG, each of which has a different TA, have the same TAT).

Optionally, the UE may indicate a UE capability that supports multiple TA maintenance (e.g. supports that “TA is identified per link per TAG”) to the base station (e.g. gNB), so that TA can be identified per link per TAG.

Optionally, the link which is used or configured or indicated to perform the initial access or the link which is configured by the network is referred to as primary link. The other links (i.e. the links that are not primary link) can be defined as “secondary link(s)” or “other link(s)”.

The TAG configuration follows the legacy TAG configuration.

As a whole, according to the first embodiment, multiple TAs are identified. At least some of the multiple TAs are identified to be associated with at least a link proposed in this application. The TAT associated with one link (i.e. associated with the TA associated with the link) or associated with multiple links (i.e. associated with each TA associated with each of the multiple links) is proposed.

A second embodiment relates to indicating multiple TA values.

According to prior art, the MAC entity of the UE maintains only one TA for one TAG. The TA of each TAG is indicated by TAC MAC CE or TAC in RAR. If legacy TAC MAC CE and/or legacy TAC in RAR are used to indicate TA when multiple TAs are introduced, ambiguity may be caused. In view of the above, several new solutions for indicating multiple TA values are proposed.

According to a first sub-embodiment of the second embodiment, the DL TRP (or DL beam set) reception is associated with UL panel (or UL beam set) transmission. The association between DL TRP and UL panel (or between DL beam set and UL beam set) can be configured or indicated or pre-defined or obtained by the procedure of beam management. Accordingly, the TAC (i.e. TAC contained in TAC MAC CE or contained in RAR) received from the DL TRP (or DL beam set) is applied for the UL panel associated with the DL TRP (or the UL beam set associated with the DL beam set). Optionally, the field ‘TAG ID’ may be ignored if TAG is not allowed (e.g. according to the first sub-embodiment of the first embodiment).

According to a second sub-embodiment of the second embodiment, a new TAC MAC CE is proposed to indicate multiple TAs. The new TAC MAC CE should identify the link, for example, by including the link ID. The new TAC MAC CE should also identify the TAG, for example, by including the TAG ID, if TAG is used in identifying the TA (e.g. according to the second, third, fourth sub-embodiments of the first embodiment). The field(s) “cell ID” can be included, if the cell (e.g. serving cell or neighbor cell) is used to indicate a link.

The new TAC MAC CE can have fixed size or variable size. For example, the new TAC MAC CE having fixed size can indicate a fixed number of TAC field(s). The new TAC MAC CE having variable size may include one or more TAC field(s), each of which indicates the TA value of one link. Whether the new TAC MAC CE has fixed size or variable size can be identified by different LCIDs. For example, the reserved values of LCIDs for DL-SCH can be used to identify the new TAC MAC CE. For example, the TAC MAC CE having fixed size may be identified by MAC subheader with LCID ‘35’, and the TAC MAC CE having variable size may be identified by MAC subheader with LCID ‘36’. Needless to say, any other value(s) of LCID(s) that have not been occupied can be used to identify new TAC MAC CE(s). In the condition that TAG is reused according to the third sub-embodiment of the first embodiment, if a legacy TAC MAC CE is received, the TAC contained in the legacy TAC MAC CE is determined as indicating the TA associated with the primary link.

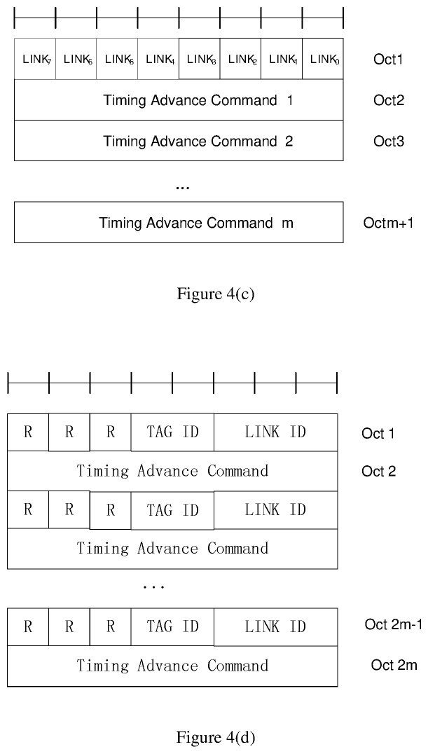

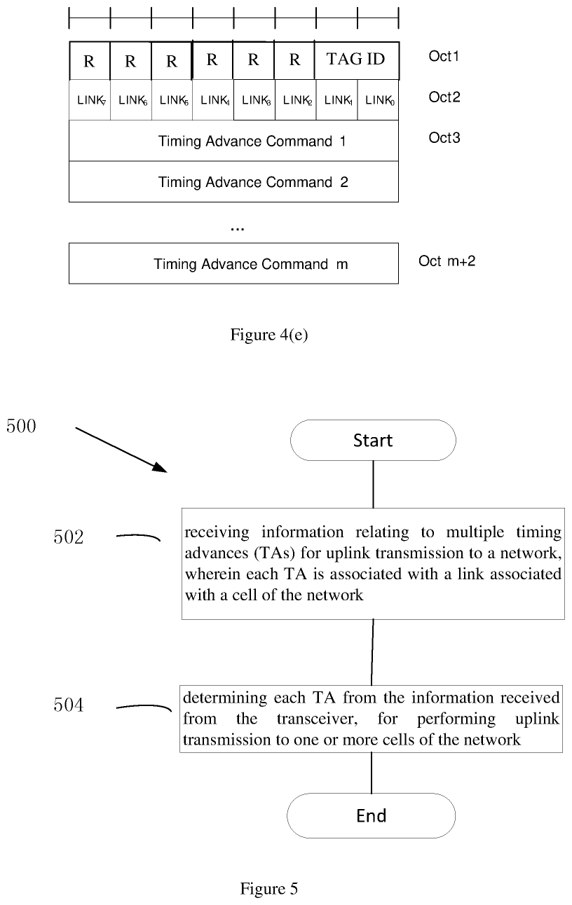

Several examples of the new TAC MAC CE formats are shown in FIGS. 4(a) to 4(e).

FIG. 4(a) illustrates a first example of TAC MAC CE having fixed size (e.g. one octet) that includes a timing advance command (TAC) (that indicates a TA) associated with one link identified by LINK ID. The LINK ID field in FIG. 4(a) has 2 bits. The TAC field in FIG. 4(a) has 6 bits.

FIG. 4(b) illustrates a second example of TAC MAC CE having variable size (e.g. m octets, where m is an integer) that indicates one or more TACs, each of which is associated with one of m links identified by m LINK IDs. As each LINK ID field has 2 bits, m can only be 1, 2, 3, or 4. Each TAC field in FIG. 4(b) has 6 bits.

FIG. 4(c) illustrates a third example of TAC MAC CE having variable size (e.g. from 2 to m+1 octets, where m is an integer from 1 to 8) that indicates one or multiple TACs, each of which is associated with one of LINK₀ to LINK₇ that represents a predetermined link. If LINKᵢ (i=0 to 7) is set to 1, a TAC associated with LINKᵢ is included, while if LINKᵢ (i=0 to 7) is set to 0, the TAC associated with LINKᵢ is not included. In other words, m is equal to the number of LINKᵢ (i=0 to 7) being set to 1. Each of LINK₀ field to LINK₇ field in FIG. 4(c) has 1 bit. Each TAC field in FIG. 4(c) has 8 bits.

FIG. 4(d) illustrates a fourth example of TAC MAC CE having variable size (e.g. 2 to 2m octets, where m is an integer) that indicates one or more TACs, each of which is associated with one link identified by one LINK ID of TAG ID (e.g. with reference to the second sub-embodiment of the first embodiment), or by one TAG ID of LINK ID (e.g. with reference to the fourth sub-embodiment of the first embodiment). Each TAG ID field in FIG. 4(d) has 2 bits. Each LINK ID field in FIG. 4(d) has 3 bits. Each TAC field in FIG. 4(d) has 8 bits. Each R (reserved) field in FIG. 4(d) has 1 bit. It is obvious that the position of “TAG ID” field, “LINK ID” field and three “R” field in one octet can be arbitrarily arranged in the one octet.

FIG. 4(e) illustrates a fifth example of TAC MAC CE having variable size (e.g. 3 to m+2 octets, where m is an integer from 1 to 8) that indicates one or more TACs, each of which is associated with one link identified by a link (indicated by one of LINK₀ to LINK₇ that represents a predetermined link) of a TAG (indicated by TAG ID) (e.g. with reference to the second sub-embodiment of the first embodiment). If LINKᵢ (i=0 to 7) is set to 1, a TAC associated with LINKᵢ of the indicated by the TAG ID is included, while if LINKᵢ (i=0 to 7) is set to 0, the TAC associated with LINKᵢ of the indicated by the TAG ID is not included. In other words, m is equal to the number of LINKᵢ (i=0 to 7) being set to 1. The TAG ID field in FIG. 4(e) has 2 bits. Each LINK ID field in FIG. 4(e) has 1 bit. Each TA command field in FIG. 4(e) has 8 bits. Each R (reserved) field in FIG. 4(e) has 1 bit. The Oct1 to Oct m+2 can be repeated to indicate the TAC for multiple TAGs with different TAG IDs.

The number of bits of each field (e.g. the number of bits of the LINK ID field, the number of bits of the TAG ID field, etc) are not limited to the number of bits indicated in each of the examples of TAC MAC CEs shown in FIGS. 4(a) to 4(e), and can be adjusted according to practical use, since the TAC MAC CE can have variable size.

According to a third sub-embodiment of the second embodiment, the MAC RAR used for indicating TAC is enhanced, if the DL TRP (or DL beam set) reception is not associated with UL panel (or UL beam set) transmission.

A legacy MAC RAR can indicate one TA to the UE in the RACH procedure, where the one TA is for a TAG (i.e. for a cell). When multiple TAs, each of which is associated with a link, should be indicated to the UE by MAC RAR, the legacy MAC RAR is necessary to be enhanced.

In particular, a new MAC RAR should identify the link associated with the TAC, for example, by including the link ID of the link. In addition, the MAC RAR may include one or more TAC fields, each of which indicates the TA associated with one link identified for example by one link ID field. The new MAC RAR should also identify the TAG, for example, by including the TAG ID, if TAG is used in identifying the TA (e.g. according to the second and the fourth sub-embodiments of the first embodiment).

Similar to the new TAC MAC CE proposed in the second sub-embodiment of the second embodiment, the new MAC RAR may have fixed size or variable size. In addition, whether the new TAC MAC CE has fixed size or variable size can be identified by different LCIDs.

The existing fields (e.g. ‘Temporary C-RNTI’ field and/or R′ field) contained in the legacy MAC RAR can be configured to have new purpose. For example, they can be used to indicate the length of the RAR payload or the number of TAC fields or the link number for which TAC is indicated, or indicate whether one or more TAC fields are included.

Incidentally, if a legacy MAC RAR is received (e.g. in the condition that TAG is reused according to the third sub-embodiment of the first embodiment), the TAC contained in the legacy MAC RAR is determined as indicating the TA associated with the primary link.

Optionally, the RACH procedure initiated by a PDCCH order can be enhanced to indicate that the UE can obtain one or multiple TAs each of which is associated with a link. This can be achieved by introducing a new DCI format, or reusing DCI format 1_0 by adding some new fields. Alternatively, this can be achieved by designing RRC or MAC signaling to initiate the RACH procedure, or introducing a new procedure.

In the above described second embodiment, a TA is indicated by a TAC. Alternatively, only for the primary link(s) or indicated link(s) or configured link(s), the TA is directly indicated by TAC. On the other hand, delta value compared with the primary or indicated or configured links can be used to indicate the TA of other link(s). For example, TA of other link(s)=delta value+TA of primary link.

A third embodiment relates to enhancement of TAT.

A TAT (e.g. timeAlignmentTimer) is a timer associated with one link (i.e. associated with the TA of the link) or multiple links (i.e. associated with the TA of each of the multiple links) configured by RRC signaling. When a TAT is running and before the TAT expires, the TA of the links associated with the TAT is valid.

(1) The starting and stopping of the TAT:

When the TAT associated with of one or multiple links is running, when a (new) TAC indicating a (new) TA of the link(s) is received in a RAR, the received TAC should be ignored.

The TAT associated with one or multiple links is started when the UE decides to apply the TA of the link. For example, when a TAC of the link is received, the TAT associated with the link (i.e. associated with the TA indicated by the TAC) is started.

When the Contention Resolution is considered not successful, the TAT associated with the link is stopped.

In addition, when the Contention Resolution is considered successful for SI request, after transmitting HARQ feedback for MAC PDU including UE Contention Resolution Identity MAC CE, the TAT associated with the link is stopped.

(2) The behavior when TAT is not running:

When the TAT (timeAlignmentTimer) associated with a link is not running, the MAC entity (of the UE) shall not perform any uplink transmission on the link except the Random Access Preamble and MSGA transmission.

In addition, when the TAT (timeAlignmentTimer) associated with the primary link (if configured) is not running, the MAC entity (of the UE) shall not perform any uplink transmission on any Serving Cell nor on any other link(s) except the Random Access Preamble and msgA (message A) transmission on the SpCell or on the primary link.

(3) The behavior when the TAT (timeAlignmentTimer) expires:

(3-1) If a TAT associated with a link expires, when there is any TAT associated with the TAG running, do not perform uplink transmission on the link associated with the expired TAT.

If all TATs associated with the links of PTAG expire, the following steps are performed: flush all HARQ buffers for all Serving Cells; notify RRC to release PUCCH for all Serving Cells, if configured; notify RRC to release SRS for all Serving Cells, if configured; clear any configured downlink assignments and configured uplink grants; clear any PUSCH resource for semi-persistent CSI reporting; consider all running timeAlignmentTimers as expired; maintain NTA defined in TS 38.211 [8] of all TAGs.

If all TATs associated with the links of a STAG (i.e. not of a PTAG) expire, the following steps are performed for all serving cells belonging to the STAG: flush all HARQ buffers; notify RRC to release PUCCH, if configured; notify RRC to release SRS, if configured; clear any configured downlink assignments and configured uplink grants; clear any PUSCH resource for semi-persistent CSI reporting; maintain NTA defined in TS 38.211 [8] of the STAG.

If the expired TAT is associated with a link that is associated with the configured uplink grants or UL resources, the transmission on the UL resources is suspended, or the resources associated with the link are cleared.

Further, if the expired TAT is associated with a link that is associated with the configured uplink grants or UL resources, and if there is any TAT associated with other link(s) running, the transmission on the UL resources is suspended, or the resources associated with the link are cleared.

If all TATs associated with the links of a TAG expire, clear all of the pre-configured resources associated with the TAG.

FIG. 5 is a schematic flow chart diagram illustrating an embodiment of a method 500 according to the present application. In some embodiments, the method 500 is performed by an apparatus, such as a remote unit (UE). In certain embodiments, the method 500 may be performed by a processor executing program code, for example, a microcontroller, a microprocessor, a CPU, a GPU, an auxiliary processing unit, a FPGA, or the like.

The method 500 may be performed by a UE and comprise 502 receiving information relating to multiple timing advances (TAs) for uplink transmission to a network, wherein each TA is associated with a link associated with a cell of the network; and 504 determining each TA from the information received from the transceiver, for performing uplink transmission to one or more cells of the network. The method may further comprise receiving one or multiple timers, wherein, each timer is associated with one or multiple links and maintains a validity of the TAs associated with the one or multiple links. In particular, the timer relates to a timing advance group (TAG) for each link, or to a link for each TAG.

In some embodiment, the method may further comprise transmitting a UE capability of supporting multiple TA maintenance.

In some embodiment, the timer relates to a timing advance group (TAG) for each link, or to a link for each TAG.

The link that is used to perform initial access is a primary link. The primary link may be associated with a cell. The one or multiple other link(s) are secondary link(s). Each secondary link may be associated with one or multiple cells.

Each TA may be indicated by a timing advance command (TAC). The TAC received from a downlink (DL) transmit-receive point (TRP) or DL beam set may be applied for an uplink (UL) panel associated with the DL TRP or a UL beam associated with the DL beam. Alternatively, each TAC is contained in a TAC medium access control (MAC) control element (CE) that identifies a link associated with the TAC. The TAC MAC CE may be of fixed size or variable size identified by MAC subheader with logical channel identity (LCID). Alternatively, the TAC contained in a TAC MAC CE that does not identify the link is determined as the TAC of the primary link. Alternatively, each TAC is contained in an MAC random access response (RAR) that identifies a link associated with the TAC. The MAC RAR may be of fixed size or variable size identified by MAC subheader with logical channel identity (LCID).

If the timer associated with a link that is associated with configured uplink grants or UL resources is expired, the transmission on the UL resources may be suspended or the resources associated with the link may be cleared.

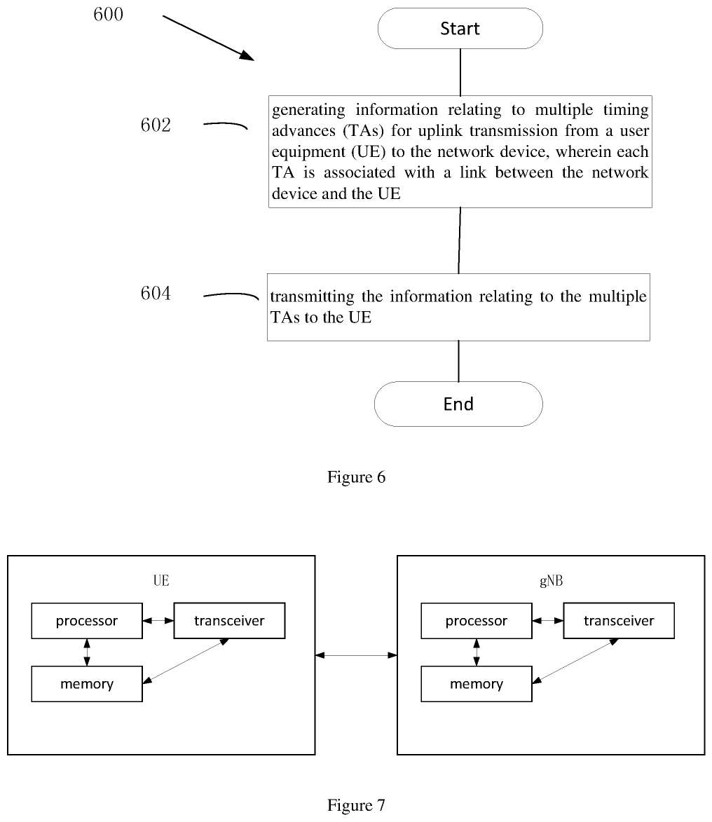

FIG. 6 is a schematic flow chart diagram illustrating a further embodiment of a method 600 according to the present application. In some embodiments, the method 600 is performed by an apparatus, such as a base unit or a network device. In certain embodiments, the method 600 may be performed by a processor executing program code, for example, a microcontroller, a microprocessor, a CPU, a GPU, an auxiliary processing unit, a FPGA, or the like.

The method 600 may be performed by a network device and comprise 602 generating information relating to multiple timing advances (TAs) for uplink transmission from a user equipment (UE) to the network device, wherein each TA is associated with a link between the network device and the UE; and 604 transmitting the information relating to the multiple TAs to the UE. The method may further comprise generating one or multiple timers, wherein, each timer is associated with one or multiple links and maintains a validity of the TAs associated with the one or multiple links; and transmitting the one or multiple timers to the UE. In particular, the timer relates to a timing advance group (TAG) for each link, or to a link for each TAG.

In some embodiment, the method may further comprise receiving a UE capability of supporting multiple TA maintenance.

In some embodiment, the timer relates to a timing advance group (TAG) for each link, or to a link for each TAG.

The link that is used to perform initial access is a primary link. The primary link may be associated with a cell. The one or multiple other link(s) are secondary link(s). Each secondary link may be associated with one or multiple cells.

Each TA may be indicated by a timing advance command (TAC). The TAC transmitted from a downlink (DL) transmit-receive point (TRP) or DL beam set may be applied for an uplink (UL) panel associated with the DL TRP or a UL beam associated with the DL beam. Alternatively, each TAC is contained in a TAC medium access control (MAC) control element (CE) that identifies a link associated with the TAC. The TAC MAC CE may be of fixed size or variable size identified by MAC subheader with logical channel identity (LCID). Alternatively, the TAC contained in a TAC MAC CE that does not identify the link is determined as the TAC of the primary link. Alternatively, each TAC is contained in an MAC random access response (RAR) that identifies a link associated with the TAC. The MAC RAR may be of fixed size or variable size identified by MAC subheader with logical channel identity (LCID).

FIG. 7 is a schematic block diagram illustrating apparatuses according to one embodiment.

Referring to FIG. 7, the UE (i.e. remote unit, or terminal device) includes a processor, a memory, and a transceiver. The processor implements a function, a process, and/or a method which are proposed in FIG. 5.

The UE comprises a processor; and a transceiver coupled to the processor, wherein the processor is configured to: receive, via the transceiver, information relating to multiple timing advances (TAs) for uplink transmission to a network, wherein each TA is associated with a link associated with a cell of the network; and determine each TA from the information received via the transceiver, for performing uplink transmission to one or more cells of the network. The processor may further configured to: receive, via the transceiver, one or multiple timers, wherein, each timer is associated with one or multiple links and maintains a validity of the TAs associated with the one or multiple links. In particular, the timer relates to a timing advance group (TAG) for each link, or to a link for each TAG.

In some embodiment, the processor is further configured to: transmit, via the transceiver, a UE capability of supporting multiple TA maintenance.

In some embodiment, the timer relates to a timing advance group (TAG) for each link, or to a link for each TAG.

The link that is used to perform initial access is a primary link. The primary link may be associated with a cell. The one or multiple other link(s) are secondary link(s). Each secondary link may be associated with one or multiple cells.

Each TA may be indicated by a timing advance command (TAC). The TAC received from a downlink (DL) transmit-receive point (TRP) or DL beam set may be applied for an uplink (UL) panel associated with the DL TRP or a UL beam associated with the DL beam. Alternatively, each TAC is contained in a TAC medium access control (MAC) control element (CE) that identifies a link associated with the TAC. The TAC MAC CE may be of fixed size or variable size identified by MAC subheader with logical channel identity (LCID). Alternatively, the TAC contained in a TAC MAC CE that does not identify the link is determined as the TAC of the primary link. Alternatively, each TAC is contained in an MAC random access response (RAR) that identifies a link associated with the TAC. The MAC RAR may be of fixed size or variable size identified by MAC subheader with logical channel identity (LCID).

If the timer associated with a link that is associated with configured uplink grants or UL resources is expired, the transmission on the UL resources may be suspended or the resources associated with the link may be cleared.

Referring to FIG. 7, the gNB (i.e. base unit or network device) includes a processor, a memory, and a transceiver. The processors implement a function, a process, and/or a method which are proposed in FIG. 6.

The network device comprises a processor; and a transceiver coupled to the processor, wherein the processor is configured to: generate information relating to multiple timing advances (TAs) for uplink transmission from a user equipment (UE) to the network device, wherein each TA is associated with a link between the network device and the UE; and transmit, via the transceiver, the information relating to multiple TAs to the UE. The processor is further configured to: generate one or multiple timers, wherein, each timer is associated with one or multiple links and maintains a validity of the TAs associated with the one or multiple links; and transmit the one or multiple timers to the UE. In particular, the timer relates to a timing advance group (TAG) for each link, or to a link for each TAG.

In some embodiment, the processor is further configured to: receive a UE capability of supporting multiple TA maintenance.

In some embodiment, the timer relates to a timing advance group (TAG) for each link, or to a link for each TAG.

The link that is used to perform initial access is a primary link. The primary link may be associated with a cell. The one or multiple other link(s) are secondary link(s). Each secondary link may be associated with one or multiple cells.

Each TA may be indicated by a timing advance command (TAC). The TAC transmitted from a downlink (DL) transmit-receive point (TRP) or DL beam set may be applied for an uplink (UL) panel associated with the DL TRP or a UL beam associated with the DL beam. Alternatively, each TAC is contained in a TAC medium access control (MAC) control element (CE) that identifies a link associated with the TAC. The TAC MAC CE may be of fixed size or variable size identified by MAC subheader with logical channel identity (LCID). Alternatively, the TAC contained in a TAC MAC CE that does not identify the link is determined as the TAC of the primary link. Alternatively, each TAC is contained in an MAC random access response (RAR) that identifies a link associated with the TAC. The MAC RAR may be of fixed size or variable size identified by MAC subheader with logical channel identity (LCID).

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive information relating to multiple timing advances (TAs) for uplink transmission to a network, wherein each TA is associated with a link associated with a cell of the network; and
determine each TA from the information received, for performing uplink transmission to one or more cells of the network.

2. The UE of claim 1, wherein the at least one processor is configured to cause the UE to:
receive one or multiple timers, wherein, each timer is associated with one or multiple links and maintains a validity of the TAs associated with the one or multiple links.

3. The UE of claim 1, wherein the at least one processor is configured to cause the UE to:
transmit a UE capability of supporting multiple TA maintenance.

4. The UE of claim 2, wherein the timer relates to a timing advance group (TAG) for each link, or to a link for each TAG.

5. The UE of claim 1, wherein each TA is indicated by a timing advance command (TAC).

6. The UE of claim 5, wherein:
the TAC received from a downlink (DL) transmit-receive point (TRP) or DL beam set is applied for an uplink (UL) panel associated with the DL TRP or a UL beam associated with the DL beam.

7. The UE of claim 5, wherein each TAC is contained in a TAC medium access control (MAC) control element (CE) that identifies a link associated with the TAC.

8. The UE of claim 7, wherein the TAC MAC CE is of fixed size or variable size identified by MAC subheader with logical channel identity (LCID).

9. The UE of claim 5, wherein the TAC contained in a TAC medium access control (MAC) control element (CE) that does not identify the link is determined as the TAC of the primary link.

10. The UE of claim 5, wherein each TAC is contained in a medium access control (MAC) random access response (RAR) that identifies a link associated with the TAC.

11. The UE of claim 10, wherein the MAC RAR is of fixed size or variable size identified by MAC subheader with logical channel identity (LCID).

12. The UE of claim 2, wherein, if the timer associated with a link that is associated with configured uplink grants or uplink (UL) resources is expired, the transmission on the UL resources is suspended or the resources associated with the link are cleared.

13. A method performed by a user equipment (UE), the method comprising:
receiving information relating to multiple timing advances (TAs) for uplink transmission to a network, wherein each TA is associated with a link associated with a cell of the network; and
determining each TA from the information received, for performing uplink transmission to one or more cells of the network.

14. An apparatus for performing a network function, the apparatus comprising:
at least one memory; and
at least one processor coupled with the at least one memory and configured to cause the apparatus to:
generate information relating to multiple timing advances (TAs) for uplink transmission from a user equipment (UE) to the apparatus, wherein each TA is associated with a link between the apparatus and the UE; and
transmit the information relating to multiple TAs to the UE.

15. (canceled)

16. A processor for wireless communication, comprising:
at least one controller coupled with at least one memory and configured to cause the processor to:
receive information relating to multiple timing advances (TAs) for uplink transmission to a network, wherein each TA is associated with a link associated with a cell of the network; and
determine each TA from the information received, for performing uplink transmission to one or more cells of the network.

17. The processor of claim 16, wherein the at least one controller is configured to cause the processor to:
receive one or multiple timers, wherein, each timer is associated with one or multiple links and maintains a validity of the TAs associated with the one or multiple links.

18. The processor of claim 16, wherein the at least one controller is configured to cause the processor to:
transmit a UE capability of supporting multiple TA maintenance.

19. The processor of claim 17, wherein the timer relates to a timing advance group (TAG) for each link, or to a link for each TAG.

20. The processor of claim 16, wherein each TA is indicated by a timing advance command (TAC).

21. The processor of claim 20, wherein:
the TAC received from a downlink (DL) transmit-receive point (TRP) or DL beam set is applied for an uplink (UL) panel associated with the DL TRP or a UL beam associated with the DL beam.
